(19) United States
(12) Patent Application Publication
(10) Pub. No.: US 2007/0243627 A1
(43) Pub. Date: Oct. 18, 2007

(54) Computerized control method and system for microfluidics and computer program product for use therein

(76) Inventors: Shuichi Takayama, Ann Arbor, MI (US); Wei Gu, Palo Alto, CA (US); Nobuyuki Futai, Ann Arbor, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/238,696

(22) Filed: Sep. 29, 2005

Related U.S. Application Data
(63) Continuation-in-part of application No. 10/548,652, filed on Oct. 3, 2005, now abandoned.
(60) Provisional application No. 60/614,781, filed on Sep. 30, 2004.

(51) Int. Cl. G01N 1/10

(52) U.S. Cl. 436/180

(57) ABSTRACT

Microfluidic devices having active features such as valves, peristaltic pumps, and mixing portions are fabricated to have a thin elastomeric membrane over the active features. The active features are activated by a tactile actuator external to the membrane. A computer executes software for controlling the actuators. The software may include a process manager that executes processes selected by a user from a process library.

### CROSS-REFERENCE TO RELATED APPLICATION

This application claims the benefit of U.S. provisional application Ser. No. 60/614,781, filed Sep. 30, 2004. This application is a continuation-in-part application of U.S. application Ser. No. 10/548,652, filed Sep. 8, 2005, which was filed on Mar. 10, 2004 as PCT application No. PCT/US2004/007246, which, in turn, claims the benefit of U.S. provisional application Ser. No. 60/403,298, filed Mar. 10, 2003.

### STATEMENT REGARDING FEDERALLY SPONSORED RESEARCH OR DEVELOPMENT

This invention was made with Government support under Contract No. DAAD 19-03-1-0168 awarded by the Army. The Government has -certain rights to the invention.

### BACKGROUND OF THE INVENTION

1. Field of the Invention

The present inventions relates to computerized control methods and systems for microfluidic devices and computer program products for use therein.

2. Background Art

Microfluidic devices are miniature devices that generally include a plurality of interconnected microchannels, reservoirs, and the like, of very small size. Microchannels may commonly have width and height dimensions of 10 μm to 300 μm, for example, although smaller and larger dimensions are possible as well. Microfluidic systems often include numerous independently controlled microfluidic pin actuators for controlling flow in the microchannels. As the number of actuators increases, user control of individual actuators becomes problematic as the user designates the state or control of each actuator.

What is needed is a system and method for controlling the operation of the actuators and, consequently, flow in the channels in the microfluidic device and, thereby, the operation of the microfluidic device.

### SUMMARY OF THE INVENTION

The present invention may provide an improved computerized control method and system for microfluidics and computer program product for use therein, wherein independent controls are provided.

Process characteristics and microfluidic device characteristics are retrieved in response to user input. Flow in a channel in the device is controlled based on the retrieved characteristics.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a block diagram illustrating a microfluidic device system;

FIG. 2 is a side schematic view of a microfluidic device including an external, non-integral tactile actuator;

FIGS. 3a through 3c are cross-sectional views of the device of FIG. 2 including the actuator taken along lines 3-3 and illustrating the action of the device of FIG. 2;

FIG. 4 is a top view of a microfluidic device including tactile actuators to select or control inlet flow and to pump or mix fluid;

FIG. 5 is a cross-sectional view illustrating a microfluidic channel having flanking voids to facilitate restriction of the channel by a tactile actuator;

FIG. 6 is an exploded perspective view of layers of an integral microfluidic device including two tactile actuator sensor arrays;

FIG. 7 is a perspective view illustrating an assembled microfluidic device of FIG. 6;

FIG. 8 is a block diagram illustrating software executed by a computer of the microfluidic device system of FIG. 1;

FIG. 9 is a block diagram flow chart illustrating operation of the software of FIG. 8;

FIG. 10 is a UML class diagram illustrating the software objects implemented for coding software that controls the microfluidic devices;

FIG. 11 is a UML sequence diagram illustrating a message sequence of objects described in FIG. 10 (“Control”, “Dot”, and “Hardware Wrapper”) to control one Braille pin;

FIG. 12 is a UML sequence diagram illustrating a message sequence of objects described in FIG. 10 (“Control”, “Timed Dot State”, and “Hardware Wrapper”) to control two Braille pins with a specified timing sequence;

FIG. 13 is a UML sequence diagram illustrating a message sequence of objects described in FIG. 10 (“Control”, “Timed Dot State”, and “Hardware Wrapper”) to control two Braille pins with a specified timing sequence;

FIG. 14 is a UML sequence diagram illustrating a message sequence of objects described in FIG. 10 (“Control”, “Key State”, and “Timed Dot State”) to activate/deactivate the timing of a Braille pin by key inputs from a user;

FIG. 15 illustrates an example of a microfluidic device library of the software of FIG. 8;

FIG. 16 illustrates an example of a process library of the software of FIG. 8; and

FIG. 17 illustrates an example of an actuator map of the software of FIG. 8.

### DETAILED DESCRIPTION OF THE PREFERRED EMBODIMENTS

Embodiments of the present invention are now described with reference to the figures where like reference numbers indicate identical or functionally similar elements.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

The present invention provides a computerized system for controlling, regulating, and detecting processes, flows, and operations of a microfluidic device. Software executed by the system controls actuators or other devices to control fluidic flow with the microfluidic device, such as flow within microchannels in the device. The software may receive user input from a graphical user interface and may automate fluidic movement in the absence of user presence.

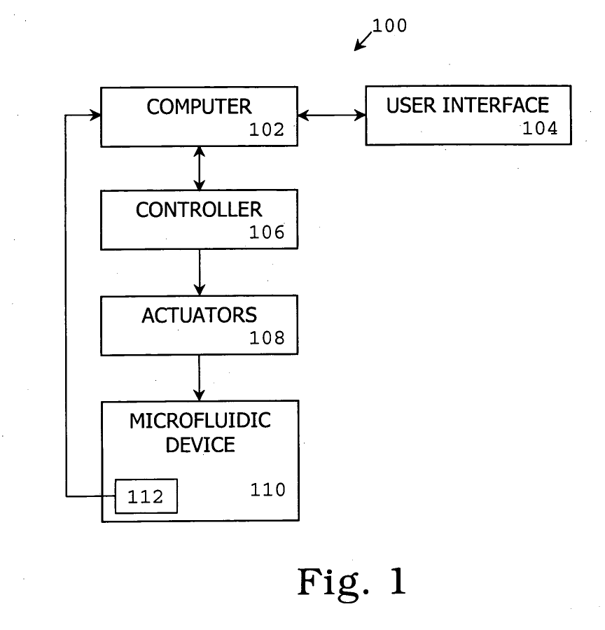

FIG. 1 is a block diagram illustrating a microfluidic device system, generally indicated at 100. A computer 102 executes software for controlling processes, flows and operations of a microfluidic device 110 though a controller 106 that provides control signals and voltages to an actuator system or actuators 108. The controller 106 may be connected to the computer 102 by a Universal Serial Bus (USB). The computer 102 may provide a menu of the processes, flows and operations to a user via a user interface 104, and receive user selections via the user interface 104.

The actuator system 108 may be an electronically controlled and addressable tactile display to operate as active component actuators on the microfluidic device 110. The actuator system 108 may include Braille cells with actuators, such as pins, for engaging corresponding elements of the microfluidic device 110 in response to the control signals and voltages from the controller 106 to control fluid processes in the device 110. The software may control the actuator system 108 to, in turn, control fluidic operations, such as valving, pumping, mixing, and cell crushing, in the microfluidic device 110. The software may control each actuator individually and simultaneously with the control of the other actuators 108. The software may receive user input for operations of individual actuators or for processes to be performed by the microfluidic device 110. The software configures the controller 106 based on a user-requested process using characteristics of the microfluidic device 110 and the actuator system 108. The software may be coded using any object oriented programming (OOP) language, such as Microsoft Visual C++ environment, or may be coded using other programming languages.

The microfluidic device 110 is suitable for the culture of a living organism in a fluid. The microfluidic device 110 controls the flow and composition of fluids provided to the living organism. The microfluidic device 110 may provide laminar, pseudo-multiple laminar or non-laminar flows. The microfluidic device 110 may perform physical operations on the living organism. The microfluidic device 110 may be used, for example, for general cell culture including cell washing and detachment, cell seeding and culture. The microfluidic device 110 may be used as a microreactor, a tissue culture device, a cell culture device, a cell sorting device, a cell crushing device, a micro flow cytometer, a motile sperm sorter, a micro carburetor, a micro spectrophotometer, or a microscale tissue engineering device. The microfluidic device 110 includes sensors 112 to determine states or flow characteristics of elements of the microfluidic device 110 or the passage of particles in a channel. The sensors 112 may be, for example, optical, electrical, or electromechanical sensors. The microfluidic device 110 may be, for example, a microfluidic device described in PCT Patent Application No. PCT/US 2004/007246, entitled “Integrated Microfluidic Control Employing Programmable Tactile Actuators,” filed Mar. 10, 2004, which is incorporated by reference herein its entirety. The microfluidic devices described herein may be formed as described in the PCT Application. The microfluidic device 110 is next described.

In one embodiment, the microfluidic device 110 includes microchannels having flow characteristics that are actively varied and formed in a compressible or distortable elastomeric material. In one embodiment, the entire microfluidic device 110 is constructed of a flexible elastomeric material, such as an organopolysiloxane elastomer (“PDMS”), as described hereinafter. However, the device substrate may also be constructed of hard, e.g., substantially non-elastic material at portions, where active control is not desired.

The microfluidic devices may contain at least one active portion that alters the shape and/or volume of chambers or passageways (“empty space”), particularly fluid flow capabilities of the device. Such active portions include, without limitation, mixing portions, pumping portions, valving portions, flow portions, channel or reservoir selection portions, cell crushing portions, and unclogging portions. These active portions all induce some change in the fluid flow, fluid characteristics, channel or reservoir characteristics, by exerting a pressure on the relevant portions of the device, and thus altering the shape and/or volume of the empty space which constitutes these features. The term “empty space” refers to the absence of substrate material. In use, the empty space is usually filled with fluids or microorganisms.

The active portions of the device are activatable by pressure to close their respective channels or to restrict the cross-sectional area of the channels to accomplish the desired active control. To achieve this purpose, the channels, reservoirs, or other elements are constructed in such a way that modest pressure from the exterior of the microfluidic device causes the channels, reservoirs or other elements (“microfluidic features”) to compress, causing local restriction or total closure of the respective feature. To accomplish this result, the walls within the plane of the device surrounding the feature are preferably elastomeric, and the external surfaces (e.g., in a planar device, an outside major surface) are elastomeric, such that a minor amount of pressure causes the external surface and optionally the internal feature walls to distort, either reducing cross-sectional area at this point or completely closing the feature.

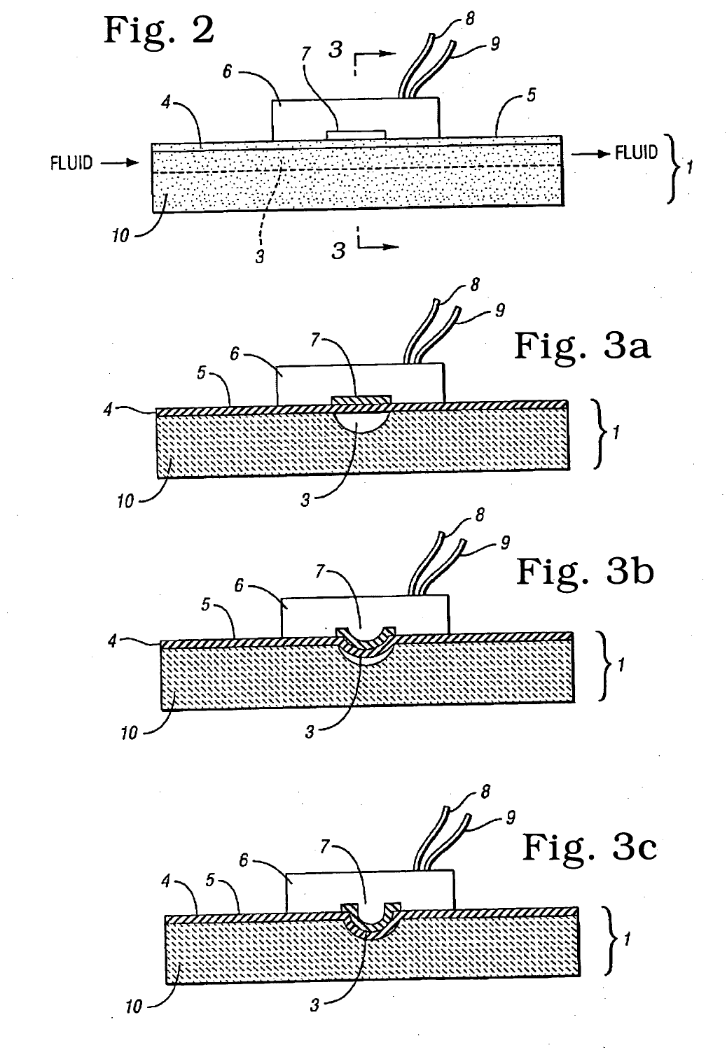

The pressure used to “activate” the active portion(s) of the device is supplied by an external tactile device, such as are used in refreshable Braille displays of the actuator system 108. The tactile actuator contacts the active portion of the device 110, and when energized, extends and presses upon the deformable elastomer, restricting or closing the feature in the active portion. This action may be illustrated by reference to FIGS. 2, 3a, 3b, and 3c.

FIG. 2 illustrates a microfluidic device 1 having a channel 2 in a substrate 10 of elastomeric material, on top of which is an elastomeric cover 4. Contacting the top surface 5 of the cover is tactile device 6, having a tactile actuator 7 extendable downwardly by application of an actuating signal through wires, 8, 9. In FIG. 3a, the device of FIG. 2 is illustrated in cross-section taken along lines 3-3, e.g., in a plane containing the tactile actuator. The channel 3 in FIG. 3a is shown unobstructed, e.g., the tactile activator has not been energized.

In FIG. 3b, an enlarged view taken along lines 3-3 of FIG. 2, the tactile activator has been partially energized, with the result that it protrudes away from the tactile device 6, exerting pressure on top surface 5 of the device, and distorting the cover 4 and the walls 11 of the channel 3. As a result, the channel cross-section is decreased, and flow restricted accordingly. A portion of channel 3 has been closed off by the bulge 12 of the energized tactile activator. In such devices, the elastomer material surrounding the feature, here the channel 3, may be, if desired, restricted to the elastomeric cover 4. In other words, the walls of the channel which are within the substrate 10 may be rigid, e.g., of micromachined silica, silicon, glass, hard plastic, or metal. The flexible elastomeric portion may be restricted in this embodiment to the cover.

In FIG. 3c, the actuator is further (“fully”) energized, as a result of which the channel 3 is completely obscured. In this case, the tactile actuator serves as an on/off valve rather than an adjustable flow controller.

In the embodiments shown, rather than close or restrict a feature by being energized, the tactile actuator may be manufactured in an extended position, which retracts upon energizing, or may be applied to the microfluidic device in an energized state, closing or restricting the passage, further opening the passage upon de-energizing.

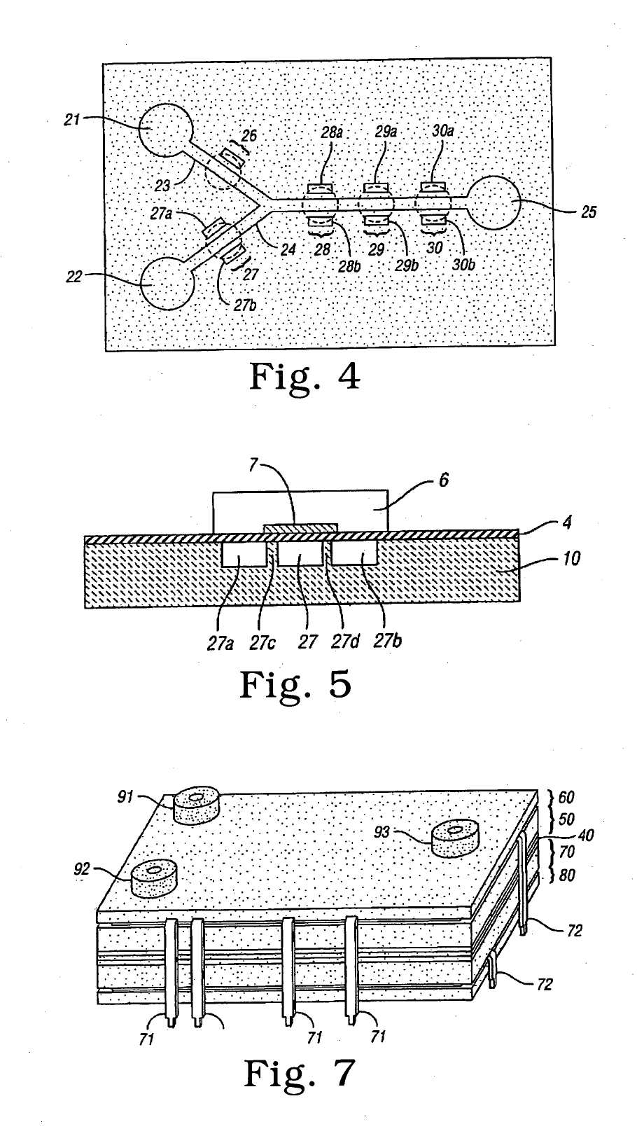

A significant improvement in the performance, not only of the subject invention devices, but of other microfluidic devices which use pressure, e.g., pneumatic pressure, to activate device features, may be achieved by molding the device to include one or more voids adjacent the channel walls. These voids allow for more complete closure or distortion of the respective feature. An example of such construction is shown in FIG. 4. In FIG. 4, the device, shown from above in plan with the elastomeric cover (4 in FIG. 2) removed, a channel 20 is supplied fluid from supply reservoirs 21, 22 through “active” supply channels 23, 24. Fluid from the channel 20 exits into outlet reservoir 25. Five active portions are shown in the device at 26, 27, 28, 29, and 30. In active portions 27 through 30, the respective channels (24, 20) are flanked by voids 27a and 27b, 28a and 28b, 29a and 29b, and 30a and 30b. Active portion 26 is flanked by but one void, 26a. The dotted circles in the active portions indicate where the tactile actuator will be energized to restrict or close the channel at these points.

In FIG. 5, the channel 24 and active portion 27 are shown in a plane orthogonal to the channel length, in this case with cover 4 and tactile device 6 and tactile activator 7 in place. When the actuator 7 bulges downwards, the walls 27c, 27d between channel 27 and its flanking voids 27a and 27b may distort, allowing for increased flexure at these active portions.

FIG. 4 also illustrates a peristaltic pump formed three active portions in series, e.g., active portions 28, 29, and 30. By successively actuating end to end, pumping action may be obtained in either direction. By cycling the pumping action back and forth, or by energizing the active portions in an alternative pattern, a mixing action rather than a pumping action may be maintained.

In one embodiment, the actuator system 108 is a programmable Braille display that includes a plurality of moveable pins that each engage a corresponding element of the microfluidic device 110 to perform a fluidic operation. The elements of the microfluidic device 110 include pumps and valves. The pins may be arranged in a regular geometric array. Such arrangement maybe used with different configurations of the microfluidic device 110. In this arrangement, some pins may not be used for particular microfluidic devices 110 because no element in the device 110 corresponds to the pin. Alternatively the pins may be selected to correspond to elements of a specific or a group of multifluidic devices 110. Each pin may be controlled independently, and individually addressable.

An example of an actuator system 108 is a Telesensory system such as the Navigator™ Braille Display with Gateway™ software, which directly translates screen text into Braille code. These devices generally comprise a linear array of “8-dot” cells, each cell and each cell “dot” of which is individually programmable. Such devices are used by the visually impaired to convert a row of text to Braille symbols, one row at a time, for example to “read” a textual message or book. The microfluidic device active portions are designed such that they will be positionable below respective actuable “dots” or protrusions on the Braille display. Braille displays are available from Handy Tech, Blazie, and Alva, among other suppliers. As will be described below, the system 100 may use various software programs for controlling the pins of the actuator system 108 by allowing the user to select processes to be performed on the organism, and then executing processes from a library.

However, to increase flexibility, it is possible to provide a regular rectangular array usable with a plurality of microfluidic devices, for example having a 10×10, 16×16, 20×100, 100×100, or other size array. The closer the spacing and the higher the number of programmable extendable protrusions, the greater is the flexibility in design of microdevices. Production of such devices follows the methods of construction known in the art. Addressability also follows from customary methods. Non-regular arrays, e.g., in patterns having actuators only where desired are also possible. Actuating pins may be used as described in U.S. Pat. No. 5,842,867, herein incorporated by reference.

Devices can also be constructed which integrate the tactile actuators with the microfluidic device. The actuators are still located external to the microfluidic device itself, but attached or bonded thereto to form an integrated whole, such as described in U.S. Pat. No. 5,580,251, herein incorporated by reference. Other types of actuator systems may be used, such as a tactile actuator device, which employs a buildup of an electrorheological fluid (see U.S. Pat. No. 5,496,174), an electromechanical Braille-type device employing shape memory wires for displacement between “on” and “off” portions (see U.S. Pat. No. 5,718,588), devices employing electrorheologic or magnetorheologic working fluids or gels, a pneumatically operated Braille device (see U.S. Pat. No. 6,354,839), “voice coil” type structures, especially those employing strong permanent magnets, devices employing shape memory alloys and intrinsically conducting polymer sheets (see U.S. Pat. Nos. 5,685,721 and 5,766,013), the patents are incorporated herein by reference.

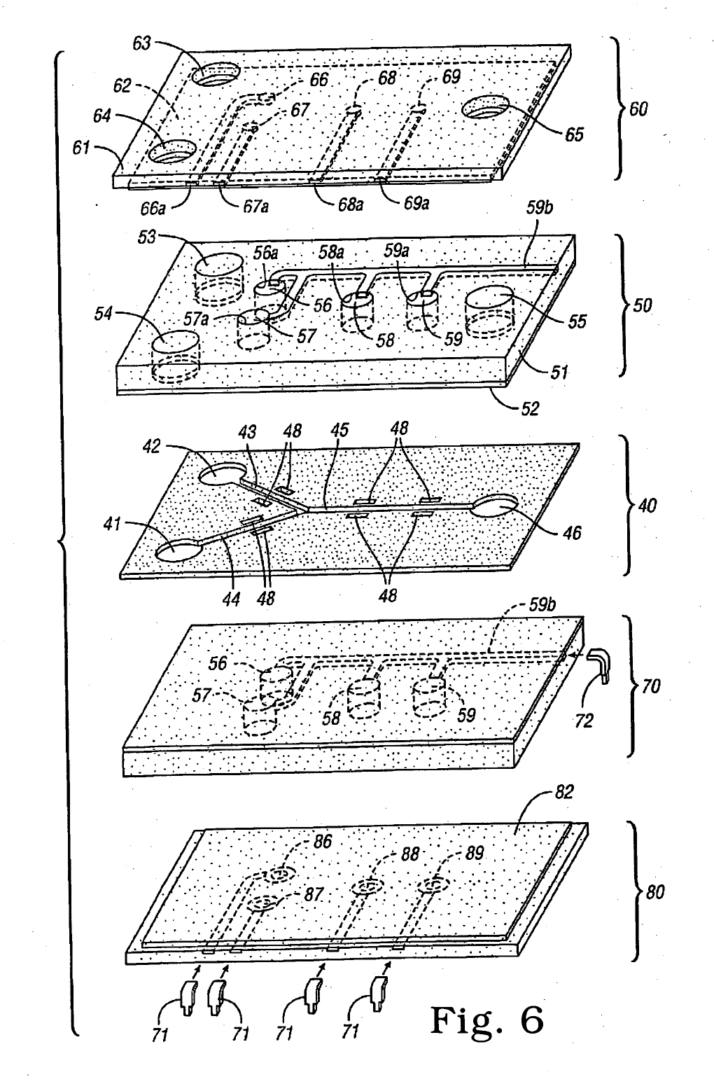

An example of a wholly integrated device is illustrated by FIG. 6, comprising nine layers and five subassemblies. The microfluidic device 40 itself is cast in a single layer of elastomer, in this case of a thickness corresponding to the desired channel height, for example 30 μm. Two inlet reservoirs 41 and 42 feed through inlet channels 43 and 44 to a central channel 45, which terminates at outlet reservoir 46. Four active portions are shown, one on each inlet channel, allowing flow control of each channel 43, 44, including switching between channels, and two further active portions along the central channel 45, which can be alternatively pulsed to mix the fluid stream in the channel, to crush cells in the channel or perform other processes. Each of the active portions of device 40 may be identified by the optional flanking voids 48 in the active portions. The reservoirs, channels, and voids in this embodiment extend through the entire thickness of the device single layer 40. However, devices of multiple layers are also useful.

Positionable atop the device 40 is a subassembly 50, which comprises a rigid substance, for example a glass, ceramic, or rigid plastic substrate 51, and elastomeric layer 52. Subassembly 50 has three through holes 53, 54, and 55, which can communicate with reservoirs 42, 41, and 46, respectively, when the layers are combined. Subassembly 50 also includes four cavities or wells, 56, 57, 58, and 59 which extend through substrate 51 but not elastomeric film 52. The inside surfaces 56a through 59a are metal plated to serve as an actuator electrode. These electrodes are commonly connected by metal foil or trace 59b, which serves as a common voltage supply to all cavities. The cavities, prior to final assembly, are filled with organic polar fluid or gel.

Subassembly 60 comprises rigid cover 61 and elastomeric insulative seal 62. Both the cover 61 and seal 62 are pierced by through holes 63, 64, and 65, which when assembled, allow communication through corresponding holes 53, 54, 55 in subassembly 50, and ultimately with reservoirs 42, 41, and 46 in the microfluidic device. The combination of these allows for the fluid reservoirs to be filled or emptied, e.g., by a syringe. Extending downward from rigid cover 61 and through seal 62 are electrode buttons 66, 67, 68, and 69, and in electrical communication with these electrodes but between the seal 62 and the rigid cover 61, are conductive traces 66a, 67a, 68a, and 69a.

Subassembly 70 is substantially a mirror image of subassembly 50, but does not contain through holes for communication with the reservoir. The various features are labeled as in subassembly 50. The conductive trace is offset from that of subassembly 50 so that the respective actuators can be independently controlled.

Subassembly 80 is substantially a mirror image of subassembly 60, but again no through holes for reservoir communication are provided. A portion of the total number of dip pin connectors 71, 72 are shown in subassemblies 70, 80. Corresponding connectors are used to connect with the electrical traces of subassemblies 50, 60, but are omitted for clarity. Electrodes 86, 87, 88, and 89 allow for individual actuation of the extendable protrusions.

FIG. 7 illustrates the appearance of a completed device, with fluid connectors 91, 92, 93 attached to the cover 61 to facilitate fluid supply to the reservoirs. The dip pin connectors on the back side of the device are not observable in this view. The entire device may be encapsulated with thermosetting resin, as is common for integrated circuits, leaving only fluid connectors 91, 92, 93 and electrical connectors 71, 72 extending out of the integrated device.

The integrated device of FIGS. 6 and 7 may also be created in separate components. In such a case, the actuator assemblies, e.g., subassemblies 50, 60 and 70, 80 may be prepared as separate units. In such a case, the microfluidic device 40 is surmounted, top and bottom, with an additional elastomeric layer. Use of such non-integral structures allows the actuator portions to be repeatedly reused, replacing only the microfluidic device layers.

Suitable Braille display devices suitable for non-integral use are available from Handy Tech Electronik GmbH, Horb, Germany, as the Graphic Window Professional™ (GWP), having an array of 24×16 tactile pins. Piezoelectric actuators are also usable, for example in devices as shown in FIGS. 5 and 6, where a piezoelectric element replaces the electrorheological fluid, and electrode positioning is altered accordingly.

The microfluidic device 110 has many uses. The software described herein automates the operation of these uses. In cell growth, the nutrients supplied may be varied to simulate availability in living systems. By providing several supply channels with active portions to close or restrict the various channels, supply of nutrients and other fluids may be varied at will. An example is a three dimensional scaffolding system to create bony tissue, the scaffolding supplied by various nutrients from reservoirs, coupled with peristaltic pumping to simulate natural circulation.

Another application involves cell crushing. Cells may be crushed by transporting them in channels through active portions and actuating channel closure to crush the cells flowing through the channels. Cell detection may be achieved, for example, by flow cytometry techniques using transparent microfluidic devices and suitable detectors. Embedding optical fibers at various angles to the channel can facilitate detection and activation of the appropriate activators. Similar detection techniques, coupled with the use of valves to vary the delivery from a channel to respective different collection sites or reservoirs can be used to sort embryos and microorganisms, including bacteria, fungi, algae, yeast, viruses, and sperm cells.

The software controls the actuator system 108 to control the pressure and thus the opening and closing of the channel and the timing. Depending on the processes to be performed, the software may address the actuators individually or in groups, and in patterns to provide actions, such as a peristaltic pumping action or a mixing action with respect to fluid in the channel. The software may monitor the sensors 112 of the microfluidic device 110 to selectively control the channel flow.

The software executed by the computer 102 is next described.

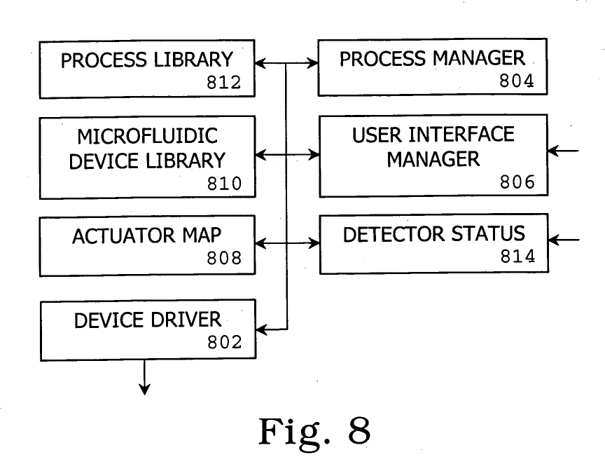

FIG. 8 is a diagram illustrating software executed by the computer 102 and the controller 106. The controller 106 executes a device driver 802 to provide control signals and drive voltages to the actuator system 108 in response to a processor manager 804 executed by the computer 102. The process manager 804 includes routines for controlling fluidic operations by the microfluidic device 110. When a process is requested, the process manager 804 controls the controller 106 via the device driver 802 to perform a sequence of events associated with the requested process. The process may include cell washing, or cell detachment. A process may include selectable subprocesses, such as a cell wash may include a subprocess for washing using PBS. In another embodiment, the process manager 804 executes the text editor described above. In this embodiment, the user may control processes on the device 110 that are not in the library, or may add the process to the software.

A user interface manager 806 controls information communicated with the process manager 804 displayed to a user on the user interface 104 and received from the user via the user interface 104. The user may select processes, timing of the processes, materials used in the processes and other features of the fluidic operations.

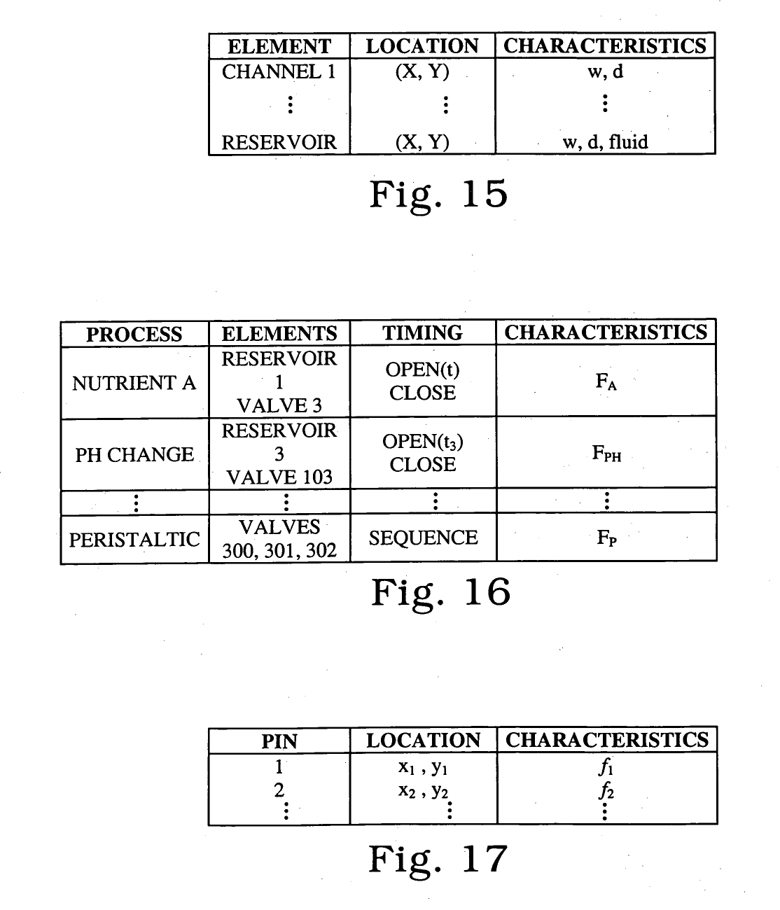

An actuator map 808 includes locations, functions, characteristics and operational parameters of the actuators of the actuator system 108. FIG. 17 illustrates an example of the actuator map 808. A microfluidic device library 810 includes locations, functions, characteristics, interconnections, and operational parameters of channels, valves, pumps and other elements of the microfluidic device 110. The microfluidic device library 810 may include dimensions and shapes of channels, flow rate characteristics of the channels, which may depend on fluid type, and valve information, such as location and flow regulation characteristics. FIG. 15 illustrates an example of the microfluidic device library 810. A process library 812 may include process objects that relate process characteristics to elements of the microfluidic device 110. For example, a peristaltic process may correspond to three valves with a defined opening and closing sequence and timing based on dimensions and fluid type. The process library 812 may include environmental change processes, which may be used to mimic in vivo culture for cell cultures or embryo growth. These processes may be substance related and may include changing the concentrations of nutrients, growth factors or vitamins, changing pH, changing the presence or absence of materials, such as growth inhibitors. The processes may be flow related and may include changes in flow rates or periodic fluctuations of fluid flow. FIG. 16 illustrates an example of the process library 812.

The process manager 804 uses the microfluidic device library 810 and the actuator map 808 to associate pins in the actuator system 108 with channels, valves and other elements of the microfluidic device 110. The process manager 804 determines the pressure or force used by the actuator system 108 to cause an associated element to perform various operations in the microfluidic device 110.

A detector status module 814 processes and stores data received from the sensors in the actuator system 108 (not shown) and the sensors 112 (see FIG. 1) in the microfluidic device 110.

As an illustrative example of peristaltic pump formed by three pins engaging the microfluidic device 110, the process manager 804 applies a pattern, such as XXO, OXX, OOX, XOX in repetition, where X is a closed position and O is an open position, to pump fluid in a channel. The resultant fluid flow is pulsatile, with transient movements in both directions. The net movement can be predicted by its linear relationship to the pattern change frequency, and flow direction can be switched by reversing the pattern of actuation.

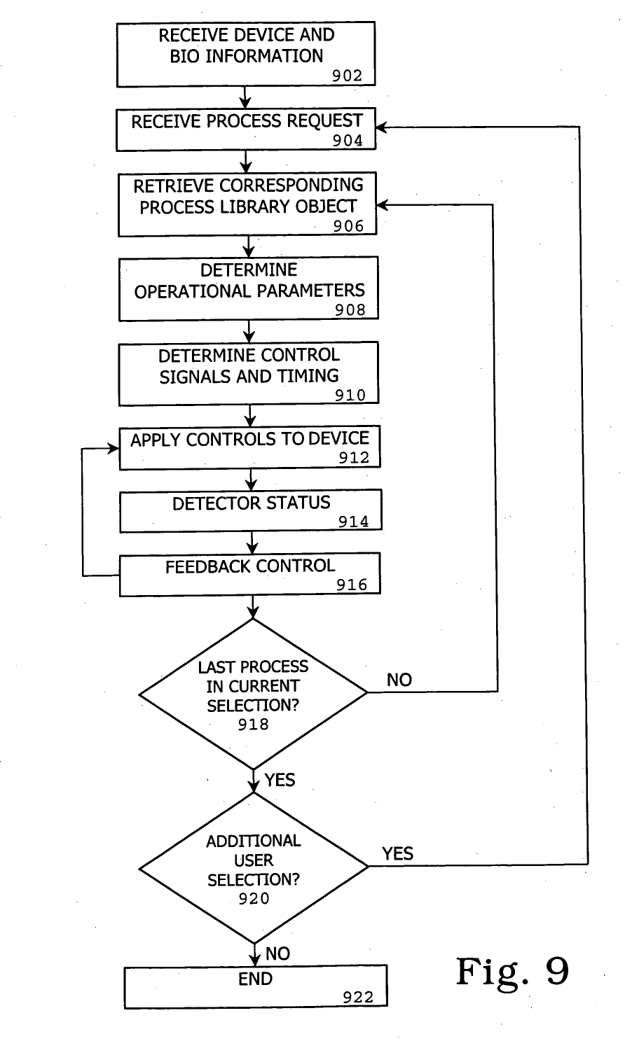

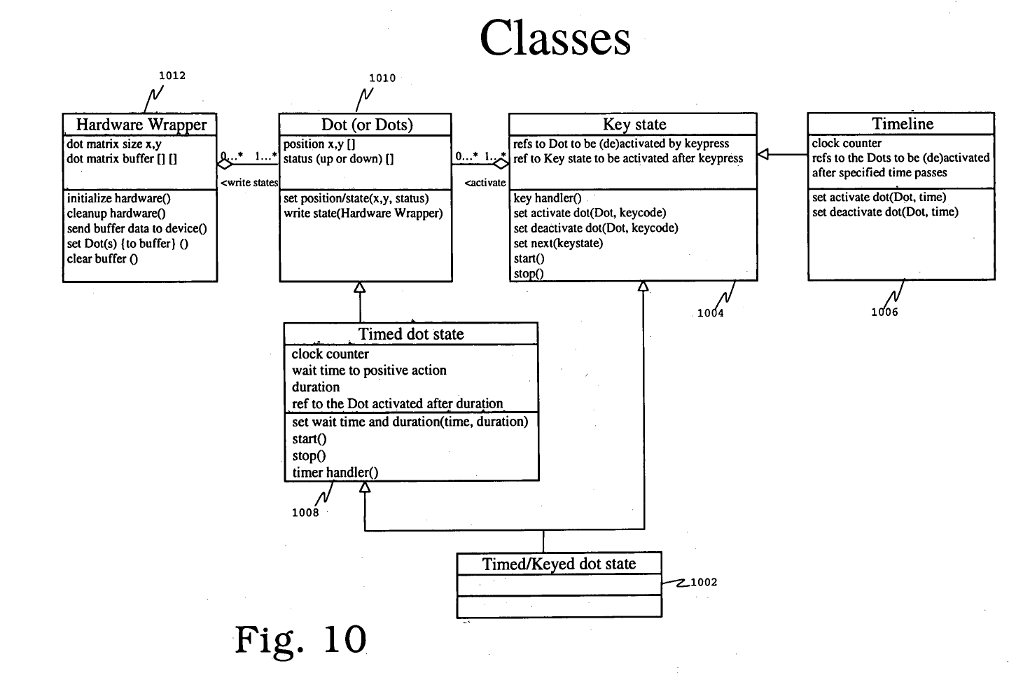

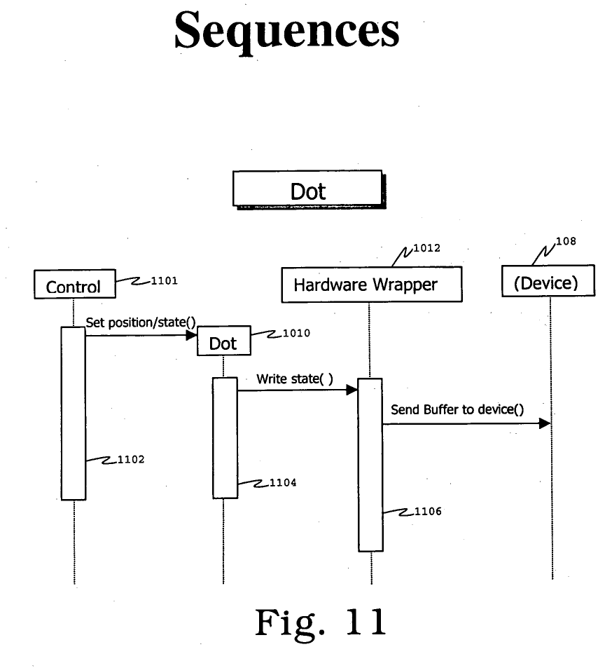

FIG. 9 is a flow chart illustrating operation of the software of FIG. 8. The user interface manager 806 receives device information and bio information (block 902) and stores the information in the microfluidic device library 810 and actuator map 808. The device information includes the location and type of elements of the microfluidic device 110 and the location and type of actuators in the actuator system 108. The user interface manager 806 receives process requests (such as pump, mix, crush or others described herein) from the user for processes to be executed on the microfluidic device 110 (block 904). The process manager 804 retrieves the corresponding process from the process library 812 (block 906) and determines the operational parameters for performing the process (block 908), which are provided to the device driver 802. The process manager 804 determines the processes to be applied at various locations in the microfluidic device 110 based on the microfluidic device library 810, and relates the processes and locations to actuators in the actuator system 108 using the actuator map 808. The device driver 802 determines control signals and timing (block 910) by generating software objects shown in FIG. 10 according to the retrieved processes the parameters described above. The software objects provide the control signals and voltages to the actuator system 108 by messagings shown in FIG. 11-14 (block 912). The detector status module 814 receives information from the detectors 112 of the state and status of the microfluidic device 110 (block 914). In response to the detector status, the process manager 804 executes feedback control (block 916) on the application of control signals to the devices (block 912). If the user has selected other processes (block 918), the process manager 804 retrieves the next corresponding object (block 906) and proceeds as described above. Otherwise, the process manager 804 determines whether another user selection is being made (block 920). If an additional selection is made, the user interface manager 806 receives the process request (block 904) and the process manager 804 proceeds as described above. Otherwise, the process ends (block 922).

In the illustrative example of FIG. 9, each element of software is described as being performed either the computer 102 or the controller 106, but may be performed by the other in other embodiments.

In one embodiment, the software operates based on a two-dimensional dot matrix configuration of the actuators of the actuator system 108. As used herein, the dots correspond to an actuator. The actuators in the matrix deform the elastomer microchannels to configure particular routes and flow rates. The software is described based on this configuration, but other configurations may be used.

FIG. 10 is a diagram illustrating software objects generated by the process manager 804 to control the device. A timed/keyed dot state object 1002 defines user selected states of dots and timing of changes in the state of dots. A key state object 1004 sets references to the dots that are to be activated or deactivated by user input, such as key pressing, and sets references to the key states based on the object 1004 and a timeline object 1006.

The timeline object 1006 functions as a clock counter and refers to dots to be activated or deactivated after specified time periods. A timed dot state object 1008 functions as a clock counter and refers to dots to be activated after a specified wait period. A dot state object 1010 includes position and status (e.g., up or down) of dots and generates write states for a hardware wrapper object 1012. The device driver may use the hardware wrapper object 1012 for execution. The hardware wrapper object 1012 includes dot matrix location and a matrix buffer for storing data sent to the actuator system 108.

The process manager 804 controls the hardware by generating instances of the state machine drives of desired patterns in the object 1002 for the objects 1004 and 1008. The object 1010 passes messages to the hardware wrapper object 1012, e.g., each clock cycle, to change the state of the actuator system 108.

The objects described for FIGS. 11-14 are described in terms of one or two dots or actuators, but may be generalized into objects covering all actuators, or into objects for each actuator, depending on software implementation, but not limiting to the present invention.

FIG. 11 is a diagram illustrating a timing sequence for the dot state object 1010. The process manager 804 generates a control signal 1101 for the dot state object 1010 to set the position and state of the actuators (event 1102). In response to the control signal 1101, the dot state object 1010 generates the write states for the hardware wrapper 1012, which may be the device driver 802 executed by the controller 106 (event 1104). The hardware wrapper 1012 sends buffer data, which includes control signals and voltages for corresponding pins, to the actuator system 108 (event 1106).

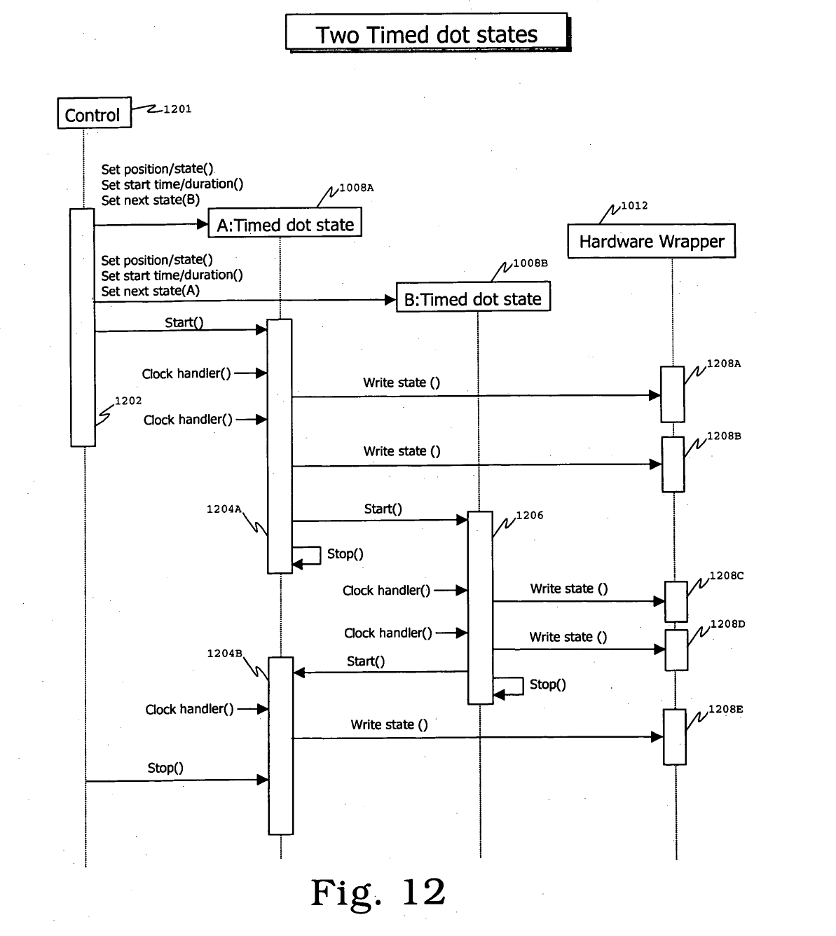

FIG. 12 is a diagram illustrating a timing sequence for a two timed dot state object of the software of FIG. 10. The process manager 804 generates a control signal 1201 for two timed dot state objects 1008A and 1008B to set the wait time to an action, a duration of the action and a next state for objects 1008A and 1008B for the actuators (event 1202). With clock signals from a clock handler, the timed dot state object 1008A sets writes states (event 1204A) for the hardware wrapper 1012 to send data to the buffer (events 1208A and 1208B) and to start the timed dot state object 1008B (event 1206). The timed dot state object 1008B sets write states for the hardware wrapper 1012 (events 1208C and 1208D) and starts the timed dot state object 1008A to set a write state (event 1204B) and set the write states for the hardware wrapper 1012 (event 1208E).

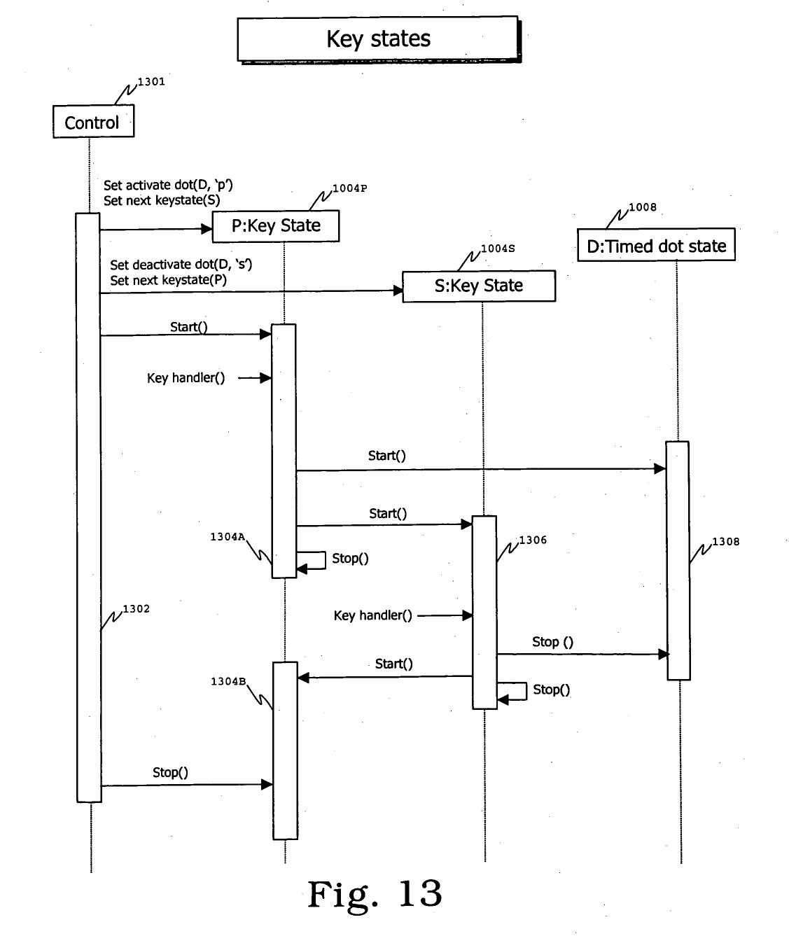

FIG. 13 is a diagram illustrating a timing sequence for a key state object of the software of FIG. 10. The process manager 804 generates a control signal 1301 for two key state objects 1004P and 1004S to set activation state for an actuator upon the next key state or deactivation state for the actuator upon the next key state for objects 1004P and 1004S, respectively (event 1302). The key handler provides the key state (event 1304A) that starts the timed dot state 1008 (event 1308), and sets the key state object 1004S for responding to deactivate key state in response to the key state object 1004P. The key handler provides the key state for the deactivation by the key state object 1004S (event 1306) that stops the timed dot state 1008 (event 1308).

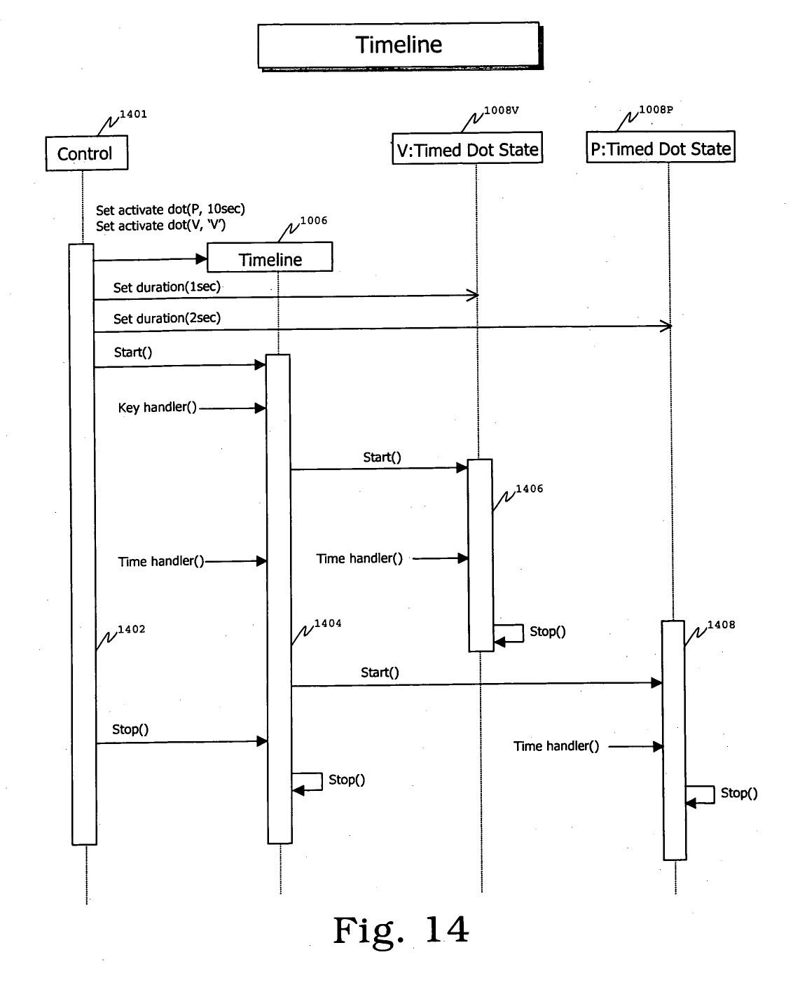

FIG. 14 is a diagram illustrating a timing sequence for a timeline object of the software of FIG. 10. The process manager 804 generates a control signal 1301 for the timeline object 1006 for controlling timed dot state objects 1008V and 1008P. Durations are set for the timed dot state objects 1008V and 1008P (event 1402) with the timeline object 1006 controlling the start of the states (event 1402) using the time handler. The activation or deactivation of the timed dot states 1008V and 1008P are stopped after the set duration (events 1406 and 1408, respectively) using the time handler.

By use of the present invention, numerous functions can be implemented on a single device. Use of multiple reservoirs for supply of nutrients, growth factors, and the like is possible. The various reservoirs make possible any combination of fluid supply, e.g., from a single reservoir at a time, or from any combination of reservoirs. This is accomplished by establishing fluid communication with a reservoir by means of a valved microchannel, as previously described. By programming the actuator system 108, each individual reservoir may be connected with a growth channel or chamber at will. By also incorporating a plurality of extendable protrusions along a microchannel supply, peristaltic pumping may be performed at a variety of flow rates. Uneven, pulsed flow typical of vertebrate circulatory systems can easily be created. Combinatorial, regulated flow with multiple pumps and valves that offer more flexibility in microfluidic cell studies are created by using a grid of tiny actuators on refreshable Braille displays and executed automatically by software in response to user selections of processes to be performed.

Upon reading this disclosure, those of skill in the art will appreciate still additional alternative structural and functional designs for a system and a process for controlling fluid operations in a microfluidic device through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method for controlling flow in a microfluidic device, the method comprising:
receiving user input regarding desired flow in the microfluidic device;
retrieving process characteristics in response to the user input;
retrieving device characteristics in response to the user input; and
controlling flow in a channel in the microfluidic device based on the retrieved device characteristics and process characteristics.

2. The method of claim 1 wherein the step of controlling flow includes directing the flow to a living organism disposed in the microfluidic device.

3. The method of claim 1 wherein the microfluidic device includes flow valves on channels in the microfluidic device, the retrieved process characteristics including control states of the flow valves, the step of controlling flow including setting appropriate control states of the flow valves to restrict and allow flow in the channels to generate a flow in response to the user input.

4. The method of claim 3 wherein the step of controlling flow includes controlling the flow valves to push fluids in the channels to generate the flow in response to the user input.

5. The method of claim 1 wherein the step of controlling flow includes:
mapping a plurality of actuators to channels in the microfluidic device;
correlating the user input to the channels; and
controlling the actuators in response to the steps of mapping and correlating.

6. The method of claim 5 wherein the step of controlling the actuators includes retrieving timing of states of the actuators.

7. The method of claim 1 wherein the process characteristics are stored in a process library and the device characteristics are stored in a device library.

8. The method of claim 1 further comprising generating a feedback signal associated with the flow or the device wherein the step of controlling is based on the feedback signal.

9. Computer code for causing a computer to execute instructions for controlling flow in a microfluidic device, the code comprising:
code for retrieving process characteristics in response to received user input regarding desired flow in the microfluidic device;
code for retrieving device characteristics in response to the user input; and
code for controlling flow in a channel in the microfluidic device based on the retrieved device characteristics and process characteristics.

10. The computer code of claim 9 wherein the code for controlling flow includes code for directing the flow to a living organism disposed in the microfluidic device.

11. The computer code of claim 9 wherein the microfluidic device includes flow valves on channels in the microfluidic device, the retrieved process characteristics including control states of the flow valves, the code for controlling flow including code for setting appropriate control states of the flow valves to restrict and allow flow in the channels to generate a flow in response to the user input.

12. The computer code of claim 11 wherein the code for controlling flow includes code for controlling the flow valves to push fluids in the channels to generate the flow in response to the user input.

13. The computer code of claim 9 wherein the code for controlling flow includes:
code for mapping a plurality of actuators to channels in the microfluidic device;
code for correlating the user input to the channels; and
code for controlling the actuators in response to the mapping and correlating.

14. The computer code of claim 11 wherein the code for controlling the actuators includes code for retrieving timing of states of the actuators.

15. The computer code of claim 9 wherein the process characteristics are stored in a process library and the device characteristics are stored in a device library.

16. The computer code of claim 9 wherein the code for controlling controls flow in the channel in response to a feedback signal associated with the flow or the device.

17. A system for controlling flow in a microfluidic device, the system being programmed to:
receive user input regarding desired flow in the microfluidic device;
retrieve process characteristics in response to the user input;
retrieve device characteristics in response to the user input; and
control flow in a channel in the microfluidic device based on the retrieved device characteristics and process characteristics.

18. The system of claim 17 wherein the system comprises at least one element to direct the flow to a living organism disposed in the microfluidic device.

19. The system of claim 17 wherein the microfluidic device includes flow valves on channels in the microfluidic device, the retrieved process characteristics including control states of the flow valves, the system being programmed to set appropriate control states of the flow valves to restrict and allow flow in the channels to generate a flow in response to the user input.

20. The system of claim 19 wherein the system is programmed to control the flow valves to push fluids in the channels to generate the flow in response to the user input.

21. The system of claim 17 wherein the flow includes:
means for mapping a plurality of actuators to channels in the microfluidic device;
means for correlating the user input to the channels; and
means for controlling the actuators in response to the mapping and correlating.

22. The system of claim 21 wherein the means for controlling the actuators includes means for retrieving timing of states of the actuators.

23. The system of claim 17 further comprising a process library for storing the process characteristics and a device library for storing the device characteristics.

24. The system of claim 17 wherein the system comprises a sensor associated with the device or the flow for generating a feedback signal and wherein the system is programmed to control flow based on the feedback signal.

25. A method for controlling a plurality of microfluidic actuators to deform a microfluidic device to alter the shape and/or volume of at least one space within the device, the method comprising:
receiving an input which represents a desired flow within the device; and
generating a set of drive signals based on process and device characteristics associated with the input to drive the plurality of microfluidic actuators and thereby cause the shape and/or volume of the at least one space to be altered to obtain the desired flow.

26. A system for controlling a plurality of microfluidic actuators to deform a microfluidic device to alter the shape and/or volume of at least one space within the device, the system being programmed to:
receive an input which represents a desired flow within the device; and
generate a set of drive signals based on process and device characteristics associated with the input to drive the plurality of microfluidic actuators and thereby cause the shape and/or volume of the at least one space to be altered to obtain the desired flow.
